(19) United States
(12) Patent Application Publication
(10) Pub. No.: US 2025/0316407 A1
(43) Pub. Date: Oct. 9, 2025

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Takuya ITO, Mie (JP)

(21) Appl. No.: 18/866,070

(22) PCT Filed: Apr. 28, 2023
(86) PCT No.: PCT/JP2023/016984

§ 371 Date: Nov. 15, 2024

(30) Foreign Application Priority Data
May 19, 2022 (JP) 2022-082430

(51) Int. Cl. H01B 7/38; H01B 7/00; H01B 15/00

(52) U.S. Cl. CPC H01B 7/385; H01B 7/0045; H01B 15/006

(57) ABSTRACT

A wiring harness 10 according to one aspect of the present disclosure includes a plurality of wires (20) and an exterior member (40) for covering the plurality of wires (20). The exterior member (40) includes a tape member (41) to be wound to bundle the plurality of wires (20). The wiring harness (10) includes a tape cutting wire (50) provided such that an intermediate part in a length direction is covered by the tape member (41), and the tape cutting wire (50) is capable of cutting the tape member (41) by an end part (51) in the length direction being pulled.

### TECHNICAL FIELD

The present disclosure relates to a wiring harness.

### BACKGROUND

Conventionally, a wiring harness is known which is provided a plurality of wires, a heating wire and an exterior member for collectively covering the plurality of wires and the heating wire (see, for example, Patent Document 1). The heating wire can melt the exterior member by being energized. In this way, a disassembly work of taking out the wires from the wiring harness for the purpose of recycling or the like is facilitated.

### PRIOR ART DOCUMENT

### Patent Document

Patent Document 1: JP 2007-221871 A

### SUMMARY OF THE INVENTION

### Problems to be Solved

However, in the wiring harness as described above, an energizing device is necessary to energize the heating wire and an operation of connecting the heating wire and the energizing device and the operation of the energizing device are necessary. Thus, there has been a problem that the disassembly work takes time and effort.

The present disclosure aims to provide a wiring harness facilitating a disassembly work.

### Means to Solve the Problem

The present disclosure is directed to a wiring harness with a plurality of wires and an exterior member for covering the plurality of wires, the exterior member including a tape member to be wound to bundle the plurality of wires, and a tape cutting wire being provided such that an intermediate part in a length direction is covered by the tape member, the tape cutting wire being capable of cutting the tape member by an end part in the length direction being pulled.

### Effect of the Invention

According to the wiring harness of the present disclosure, a disassembly work is facilitated.

### BRIEF DESCRIPTION OF THE DRAWINGS

FIG. 1 is a schematic plan view of a wiring harness in one embodiment.

FIG. 2 is a schematic transverse section of the wiring harness in the embodiment.

FIG. 3 is a schematic plan view showing functions of the wiring harness in the embodiment.

FIG. 4 is a schematic plan view showing the functions of the wiring harness in the embodiment.

FIG. 5 is a schematic transverse section of a wiring harness in another example.

FIG. 6 is a schematic plan view of a wiring harness in another example.

FIG. 7 is a schematic plan view of a wiring harness in another example.

FIG. 8 is a schematic plan view of a wiring harness in another example.

### DETAILED DESCRIPTION TO EXECUTE THE INVENTION

### Description of Embodiments of Present Disclosure

First, embodiments of the present disclosure are listed and described below.
[1] The wiring harness of the present disclosure is provided with a plurality of wires and an exterior member for covering the plurality of wires, the exterior member including a tape member to be wound to bundle the plurality of wires, and a tape cutting wire being provided such that an intermediate part in a length direction is covered by the tape member, the tape cutting wire being capable of cutting the tape member by an end part in the length direction being pulled.

According to this configuration, the tape member can be easily cut by pulling the end part of the tape cutting wire. Therefore, a disassembly work of taking out the wires from the wiring harness is facilitated.
[2] In [1] described above, the tape cutting wire may be a wire dedicated for tape cutting.

According to this configuration, the tape cutting wire can be suitable for cutting the tape member.
[3] In [2] described above, the tape cutting wire may be thinner in diameter than the wires.

According to this configuration, the tape member is easily cut.
[4] In [2] or [3] described above, the tape cutting wire may be made of a single material.

According to this configuration, the tape cutting wire has a simple configuration.
[5] In [1] described above, the tape cutting wire may include at least one of the plurality of wires.

According to this configuration, the tape member can be easily cut without using a wire material different from the wires.
[6] In any one of [1] to [5] described above, the tape cutting wire may have an angular transverse cross-sectional shape.

According to this configuration, the tape member is easily cut.

[7] In any one of [1] to [6] described above, the tape member may include an inner tape member helically wound on the plurality of wires such that parts in a width direction of the tape member overlap.

According to this configuration, the plurality of wires can be firmly bundled.
[8] In any one of [1] to [7] described above, the exterior member may include a tube member for covering the tape member while including a slit entirely in the length direction and an outer tape member to be wound on the tube member, and the tape cutting wire may be capable of cutting the outer tape member together with the tape member by the end part being pulled.

According to this configuration, since the plurality of wires can be inserted into the tube member through the slit, the tube member can be mounted on the plurality of wires from outside. Further, by winding the outer tape member on the tube member, the wires are prevented from protruding through the slit. In this way, the plurality of wires are protected by the tube member. The outer tape member can be easily cut together with the tape member by pulling the end part while aligning the position of the end part of the tape cutting wire with that of the slit. Therefore, the disassembly work of taking out the wires from the wiring harness is facilitated.
[9] In [8] described above, the outer tape member may be helically wound on an outer periphery of the tube member such that a part of the outer tape member wound later on the outer periphery of the tube member does not overlap a part of the outer tape member wound previously on the outer periphery of the tube member.

According to this configuration, since the position of the slit can be visually confirmed through a gap of the outer tape member, the position of the end part of the tape cutting wire can be easily aligned with that of the slit.
[10] In any one of [1] to [7] described above, the exterior member may be composed only of the tape member.

According to this configuration, a simpler configuration is obtained as compared to the case where the exterior member includes member(s) other than the tape member.
[11] In any one of [1] to [10] described above, the wiring harness may be provided with terminals to be fixed to both end parts of each of the plurality of wires, fixing members to be fixed to both end parts of the tape cutting wire, and connectors, the terminals and the fixing members being fixed to the connectors.

According to this configuration, the both end parts of each wire and the tape cutting wire can be fixed to the connectors. This prevents the both end parts of each wire from freely moving or the tape cutting wire from accidentally coming out from the tape member.
[12] In [11] described above, the fixing members may be terminals.

According to this configuration, the fixing members can be handled similarly to the terminals to be fixed to the both end parts of each of the plurality of wires.
[13] In [11] In described above, the fixing members may be rubber plugs.

According to this configuration, it is possible to prevent the intrusion of a liquid into the connectors through locations where the fixing members are fixed.

### DETAILS OF EMBODIMENT OF PRESENT DISCLOSURE

A specific example of a wiring harness of the present disclosure is described below with reference to the drawings. For the convenience of description, some components may be shown in an exaggerated or simplified manner in each drawing. Further, a dimension ratio of each part may be different in each drawing. “Parallel”, “orthogonal” and “true circular” in this specification mean not only strictly parallel, orthogonal and true circular, but also substantially parallel, orthogonal and true circular within a range in which functions and effects in this embodiment are achieved. Note that the present invention is not limited to these illustrations, but is represented by claims and intended to include all changes in the scope of claims and in the meaning and scope of equivalents.

### (Configuration of Wiring Harness 10)

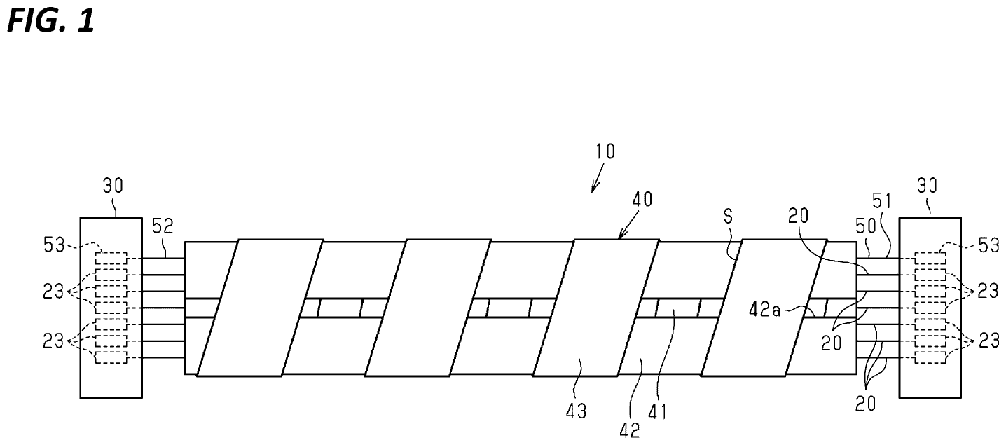

As shown in FIG. 1, a wiring harness 10 is provided with a plurality of wires 20, connectors 30, an exterior member 40 and a tape cutting wire 50.

### (Configuration of Wire 20)

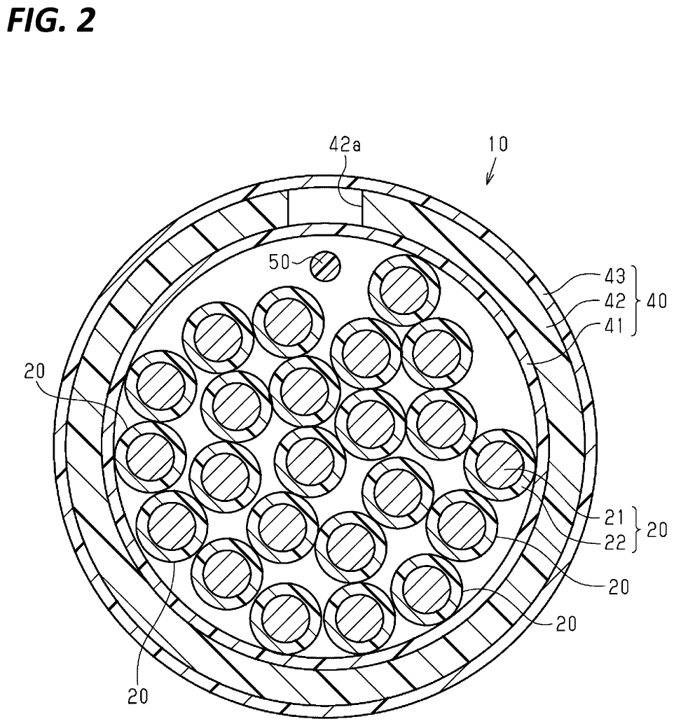

As shown in FIG. 2, the wire 20 includes a core wire 21 and an insulation coating 22 covering the outer periphery of the core wire 21. The core wire 21 of this embodiment has a circular transverse cross-sectional shape. Further, the insulation coating 22 has a circular annular transverse cross-sectional shape. Note that the number of the wires 20 is different in FIGS. 1 and 2. A smaller number of the wires 20 are schematically shown in FIG. 1.

As shown in FIG. 1, terminals 23 are fixed to both end parts of each of the plurality of wires 20. The terminal 23 of this embodiment is crimped to the core wire 21 of the wire 20.

### (Configuration of Connectors 30)

The connectors 30 are respectively provided on both end parts of the plurality of wires 20. The terminals 23 are fixed to the connectors 30. For example, the connector 30 includes insertion portions and engaging pieces. If the terminal 23 is inserted into the insertion portion, the engaging piece is engaged with the terminal 23 to prevent the terminal 23 from coming out, thereby being fixed to the terminal 23. Note that the connector 30 is connected to a connector of an unillustrated electrical device, and the core wires 21 of the wires 20 are electrically connected to the electrical device in a connected state.

### (Configuration of Exterior Member 40)

The exterior member 40 of this embodiment includes an inner tape member 41 serving as a tape member, a tube member 42 and an outer tape member 43 and covers the plurality of wires 20. The exterior member 40 is shorter in length than the wires 20 between the connectors 30 and covers intermediate parts of the wires 20.

The inner tape member 41 is wound to bundle the plurality of wires 20. The inner tape member 41 is helically wound on the plurality of wires 20 such that parts in a width direction of the inner tape member 41 overlap. That is, the inner tape member 41 is wound on the plurality of wires 20 in an overlapping manner. In this embodiment, the inner tape member 41 is wound half-wrapped on the plurality of wires 20 such that substantially halves in the width direction of the inner tape member 41 overlap. The inner tape member 41 of this embodiment is an adhesive tape and wound on the plurality of wires 20.

The tube member 42 is formed into a tubular shape including a slit 42a entirely in a length direction and covers the inner tape member 41. The tube member 42 is made of a resin material or a rubber material to be flexible. The plurality of wires 20 can be inserted into the tube member 42 while widening the slit 42a. That is, the tube member 42 can be mounted on the plurality of wires 20 from outside.

The outer tape member 43 is wound on the outer periphery of the tube member 42. The outer tape member 43 is helically wound on the tube member 42 such that a gap S is formed in the length direction of the tube member 42. In particular, the outer tape member 43 is helically wound on the outer periphery of the tube member 42 such that a part of the outer tape member 43 wound later on the outer periphery of the tube member 42 does not overlap a part of the outer tape member 43 wound previously on the outer periphery of the tube member 42. That is, the outer tape member 43 is roughly wound on the tube member 42. The outer tape member 43 of this embodiment is an adhesive tape and wound on the tube member 42. Note that the inner tape member 41, the tube member 42 and the outer tape member 43 are schematically shown to have a true circular shape in FIG. 2.

### (Configuration of Tape Cutting Wire 50)

The tape cutting wire 50 is provided such that an intermediate part in the length direction is covered by the inner tape member 41. The tape cutting wire 50 is longer than a length from one end to the other end of the inner tape member 41 along the length direction of the plurality of wires 20, and the intermediate part thereof is covered by the inner tape member 41. The tape cutting wire 50 can cut the inner tape member 41 by a first end part 51, which is an end part in the length direction, being pulled.

More specifically, the tape cutting wire 50 is a wire dedicated for tape cutting, which wire is arranged similarly to the wires 20, but does not function as the wire 20. In one example, the plurality of wires 20 may be electrically conductive wires or metal wires and the tape cutting wire 50 may be an electrically insulated wire or a synthetic resin wire.

As shown in FIG. 2, the tape cutting wire 50 is formed to be thinner in diameter than the wires 20. The tape cutting wire 50 has a circular transverse cross-sectional shape. The tape cutting wire 50 is made of a single material. The tape cutting wire 50 of this embodiment is made of nylon having high flame retardancy. The tape cutting wire 50 can cut the outer tape member 43 together with the inner tape member 41 by the first end part 51 being pulled. That is, the tape cutting wire 50 is set to have rigidity capable of cutting the outer tape member 43 together with the inner tape member 41 by the first end part 51 being pulled.

As shown in FIG. 1, terminals 53 serving as fixing members are fixed to the first end part 51 of the tape cutting wire 50 and a second end part 52, which is an end part opposite to the first end part 51. The terminals 53 of this embodiment are crimped to the tape cutting wire 50. In one example, the terminals 53 to be fixed to the tape cutting wire 50 and the terminals 23 to be fixed to the wires 20 have the same product number. The terminals 53 fixed to the tape cutting wire 50 are fixed to the connectors 30, similarly to the terminals 23 fixed to the wires 20. For example, the connector 30 includes an insertion portion and an engaging piece. If the terminal 53 is inserted into the insertion portion, the engaging piece is engaged with the terminal 53 to prevent the terminal 53 from coming out, thereby being fixed to the terminal 53.

Next, functions of the wiring harness 10 configured as described above are described.

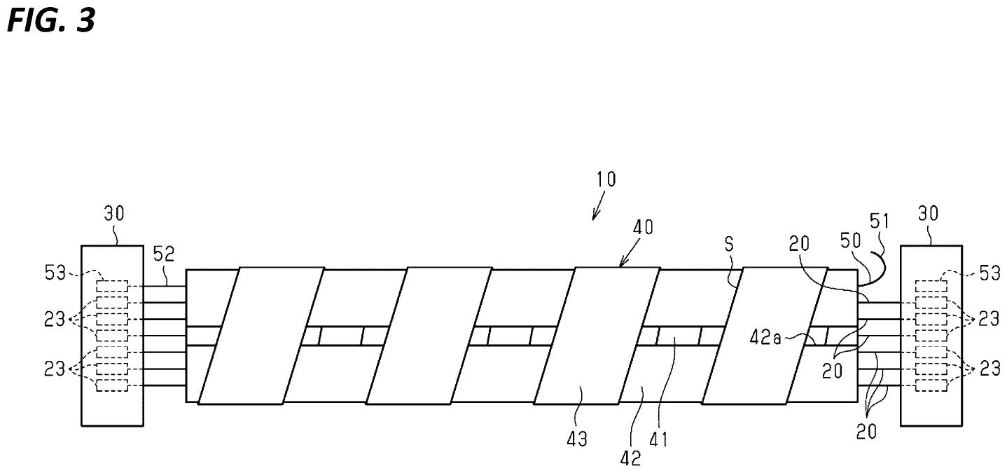

As shown in FIG. 3, for example, in the case of taking out the wires 20 from the wiring harness 10 for the purpose of recycling or the like, the first end part 51 of the tape cutting wire 50 is first removed from the connector 30. Note that, in this case, the first end part 51 may be cut off from the terminal 53 or the terminal 53 may be pulled out from the connector 30 together with the first end part 51, using a jig or the like.

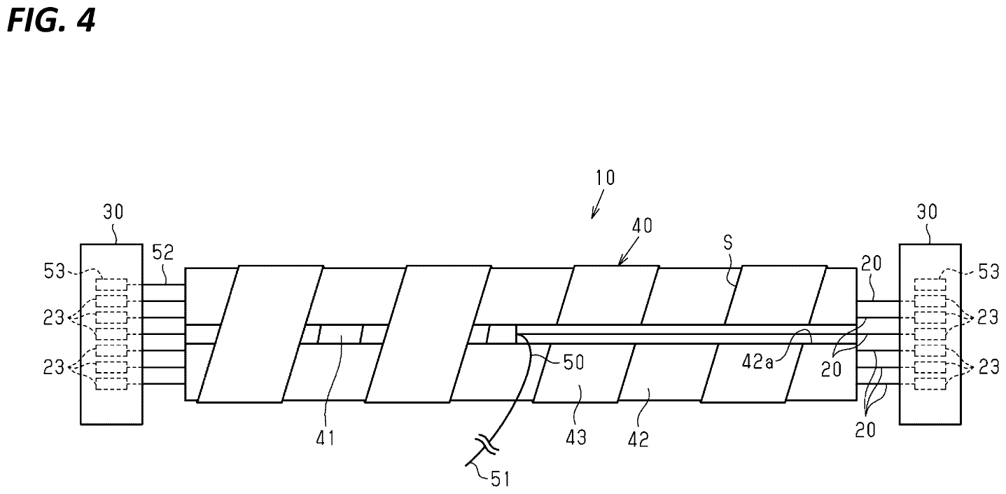

Subsequently, if the first end part 51 is pulled with the position of the first end part 51 aligned with that of the slit 42a as shown in FIG. 4, the inner tape member 41 is cut by the tape cutting wire 50. Note that a pulling direction of the first end part 51 is a cutting direction of the inner tape member 41 and, for example, a direction toward the second end part 52 outside the exterior member 40. At this time, the inner tape member 41 is cut along an extension direction of the slit 42a. Further, at this time, the outer tape member 43 is also cut along the extension direction of the slit 42a by the tape cutting wire 50.

Subsequently, the plurality of wires 20 are taken out to the outside of the tube member 42 through the slit 42a while widening the slit 42a, whereby a disassembly work is completed.

Next, effects of the above embodiment are described below.
(1) The inner tape member 41 can be easily cut by pulling the first end part 51 of the tape cutting wire 50. Thus, the disassembly work of taking out the wires 20 from the wiring harness 10 is facilitated. As a result, for example, the wires 20 are easily recycled.
(2) Since the tape cutting wire 50 is the wire dedicated for tape cutting and not functioning as the wire 20, the tape cutting wire 50 can be suitable for cutting the inner tape member 41.
(3) Since the tape cutting wire 50 is thinner in diameter than the wires 20, the inner tape member 41 is easily cut.
(4) Since being made of the single material, the tape cutting wire has a simple configuration. Further, since being made of nylon having high flame retardancy, the tape cutting wire 50 of this embodiment is prevented from being melted, for example, even if being arranged near a component, which gets hot, such as an engine.
(5) Since the inner tape member 41 is helically wound on the plurality of wires 20 such that parts in the width direction of the inner tape member 41 overlap, the plurality of wires 20 can be firmly bundled.
(6) The exterior member 40 includes the tube member 42 for covering the inner tape member 41 while including the slit 42a entirely in the length direction and the outer tape member 43 to be wound on the tube member 42. Thus, the plurality of wires 20 can be inserted into the inside of the tube member 42 through the slit 42a, wherefore the tube member 42 can be mounted from the outside of the plurality of wires 20. Further, the wires 20 are prevented from protruding through the slit 42a by winding the outer tape member 43 on the tube member 42. In this way, the plurality of wires 20 are protected by the tube member 42. The outer tape member 43 can be easily cut together with the inner tape member 41 by pulling the first end part 51 while aligning the position of the first end part 51 of the tape cutting wire 50 with that of the slit 42a. Therefore, the disassembly work of taking out the wires 20 from the wiring harness 10 is facilitated.
(7) The outer tape member 43 is helically wound on the tube member 42 such that the gap S is formed in the length direction of the tube member 42. Thus, the position of the slit 42a can be confirmed through the gap S, wherefore the position of the first end part 51 of the tape cutting wire 50 can be easily aligned with that of the slit 42a.
(8) The wiring harness is provided with the terminals 23 to be fixed to the both end parts of each of the plurality of wires 20, the terminals 53 as fixing members to be fixed to the first and second end parts 51, 52 of the tape cutting wire 50 and the connectors 30, to which the terminals 23, 53 are fixed. Thus, the both end parts of each wire 20 and the first and second end parts 51, 52 of the tape cutting wire 50 can be fixed to the connectors 30. This can, for example, prevent the both end parts of each wire 20 from freely moving or the tape cutting wire 50 from accidentally coming out from the inner tape member 41.
(9) Since the fixing members to be fixed to the first and second end parts 51, 52 are the terminals 53, the fixing members can be handled similarly to the terminals 23 to be fixed to the both end parts of each of the plurality of wires 20.

This embodiment can be modified and carried out as follows. This embodiment and the following modifications can be carried out in combination with technically contradicting each other.
Although the tape cutting wire 50 has the circular transverse cross-sectional shape in the above embodiment, there is no limitation to this and a tape cutting wire may have an angular transverse cross-sectional shape.

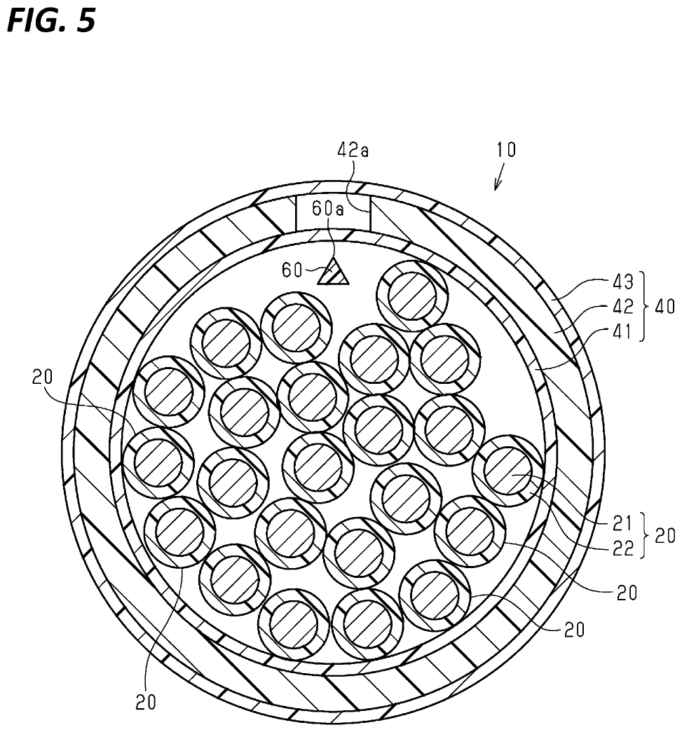

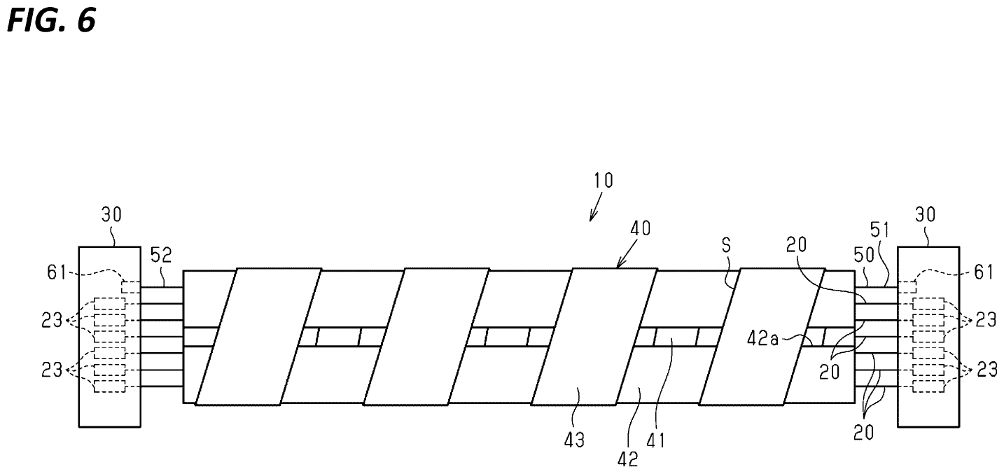

For example, as shown in FIG. 5, a tape cutting wire 60 may have a triangular transverse cross-sectional shape having angles 60a. Further, the tape cutting wire 60 may have a rectangular or star transverse cross-sectional shape having angles. Then, the inner tape member 41 is more easily cut by the angle.
In one example, the terminals 23 to be fixed to the wires 20 and the terminals 53 to be fixed to the tape cutting wire 50 may be electrically conductive terminals. In another example, the terminals 53 to be fixed to the tape cutting wire 50 may be non-electrically conductive terminals and the terminals 23 to be fixed to the wires 20 may be electrically conductive terminals. Although the fixing members to be fixed to the first and second end parts 51, 52 are the terminals 53 in the above embodiment, other fixing members may be used. For example, as shown in FIG. 6, the fixing members to be fixed to the first and second end parts 51, 52 may be rubber plugs 61. The rubber plugs 61 may be fixed to the connectors 30, for example, by adhesion. Then, it is possible to prevent the intrusion of a liquid into the connectors 30 through locations where the rubber plugs 61 are fixed.
Although the tape cutting wire 50 is a wire dedicated for tape cutting and not functioning as the wire 20 in the above embodiment, there is no limitation to this and one of the plurality of wires 20 may be used as a tape cutting wire.

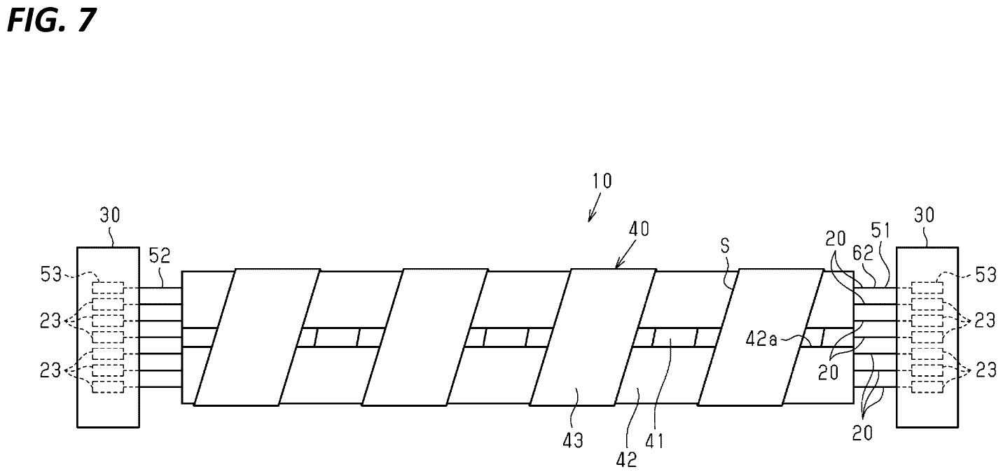

For example, as shown in FIG. 7, one of the plurality of wires 20 may be used as a tape cutting wire 62. This tape cutting wire 62 includes a core wire 21 and an insulation coating 22 (see FIG. 2) similarly to the other wires 20 and can function as the wire 20. Note that the tape cutting wire 62 may function as the wire 20, i.e. may be so used that a current flows therein, or may not function as the wire 20. The use of the tape cutting wire 62 eliminates a need to use a wire material different from the wires 20. Further, the tape cutting wire 62 may have an angular transverse cross-sectional shape.
Although the exterior member 40 includes the inner tape member 41, the tube member 42 and the outer tape member 43 in the above embodiment, another configuration may be adopted if at least the inner tape member 41 is included.

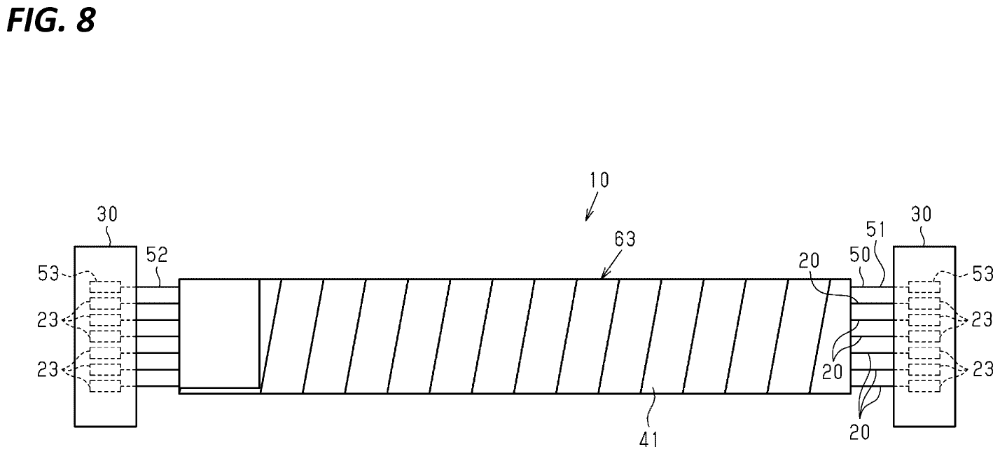

For example, as shown in FIG. 8, an exterior member 63 may be composed only of the inner tape member 41. Then, the configuration of the wiring harness 10 is simplified as compared to the case where an exterior member includes member(s) other than the inner tape member 41.
Although the tape cutting wire 50 is thinner in diameter than the wires 20 in the above embodiment, there is no limitation to this and the tape cutting wire 50 may have the same diameter as the wires 20 or may be thicker in diameter than the wires 20.
Although the tape cutting wire 50 is made of the single material in the above embodiment, there is no limitation to this and the tape cutting wire 50 may be made of a plurality of types of materials. Further, although the tape cutting wire 50 is made of nylon having high flame retardancy in the above embodiment, there is no limitation to this and the tape cutting wire 50 may be made of a single material other than nylon having high flame retardancy.
Although the inner tape member 41 is helically wound such that parts in the width direction of the inner tape member 41 overlap in the above embodiment, there is no limitation to this and the inner tape member 41 may be wound such that parts in the width direction of the inner tape member 41 do not overlap.
Although the outer tape member 43 is helically wound such that the gap S is formed in the length direction of the tube member 42 in the above embodiment, there is no limitation to this and the outer tape member 43 may be helically wound such that parts in the width direction of the outer tape member 43 overlap. Further, the outer tape member 43 may be wound on the tube member 42 such that the position of the slit 42a can be visually confirmed from outside at end parts in the length direction of the tube member 42 while being wound such that parts in the width direction of the outer tape member 43 overlap. For example, the outer tape member 43 may be wound only on an intermediate part in the length direction of the tube member 42.
Although the wiring harness 10 is provided with the connectors 30 in the above embodiment, there is no limitation to this and the connectors 30 may not be provided. Note that, in this case, the first and second end parts 51, 52 of the tape cutting wire 50 need to be fixed to members other than the connectors 30 or need not be fixed to anywhere. Further, if the first and second end parts 51, 52 of the tape cutting wire 50 are not fixed, the second end part 52 needs to be, for example, held or also simultaneously pulled when the first end part 51 is pulled.
As in the example shown in FIG. 4, a wiring harness (10) according to the shown embodiment can be provided a plurality of electrically conductive terminals (23) respectively mechanically and electrically connected to a plurality of electrically conductive end parts of the plurality of wires (20) and two fixing members (53) for respectively supporting the both end parts of the tape cutting wire (50; 60; 62). As in the example shown in FIG. 4, the tape cutting wire (50; 60; 62) may be configured to allow one end part selected out of the both end parts of the tape cutting wire (50; 60; 62) to be separated from the corresponding one of the two fixing members (53) while the mechanical and electrical connection of the plurality of electrically conductive end parts of the plurality of wires (20) and the plurality of electrically conductive terminals (23) is maintained.

List of Reference Numerals

| | |
|---|---|
| 10 | wiring harness |
| 20 | wire |
| 21 | core wire |
| 22 | insulation coating |
| 23 | terminal |
| 30 | connector |
| 40 | exterior member |
| 41 | inner tape member (exterior member, tape member) |
| 42 | tube member (exterior member) |
| 42a | slit |
| 43 | outer tape member (exterior member, tape member) |
| 50 | tape cutting wire (wire dedicated for tape cutting) |
| 51 | first end part (end part) |
| 52 | second end part (end part) |
| 53 | terminal (fixing member) |
| 60 | tape cutting wire (wire dedicated for tape cutting) |
| 60a | angle |
| 61 | rubber plug (fixing member) |
| 62 | tape cutting wire (wire) |
| 63 | exterior member |
| S | gap |

1. A wiring harness, comprising:
a plurality of wires; and
an exterior member for covering the plurality of wires,
the exterior member including a tape member to be wound to bundle the plurality of wires, and
a tape cutting wire being provided such that an intermediate part in a length direction is covered by the tape member, the tape cutting wire being capable of cutting the tape member by an end part in the length direction being pulled.

2. The wiring harness of claim 1, wherein the tape cutting wire is a wire dedicated for tape cutting.

3. The wiring harness of claim 2, wherein the tape cutting wire is thinner in diameter than the wires.

4. The wiring harness of claim 2, wherein the tape cutting wire is made of a single material.

5. The wiring harness of claim 1, wherein the tape cutting wire includes at least one of the plurality of wires.

6. The wiring harness of claim 1, wherein the tape cutting wire has an angular transverse cross-sectional shape.

7. The wiring harness of claim 1, wherein the tape member includes an inner tape member helically wound on the plurality of wires such that parts in a width direction of the tape member overlap.

8. The wiring harness of claim 1, wherein:
the exterior member includes a tube member for covering the tape member while including a slit entirely in the length direction and an outer tape member to be wound on the tube member, and
the tape cutting wire is capable of cutting the outer tape member together with the tape member by the end part being pulled.

9. The wiring harness of claim 8, wherein the outer tape member is helically wound on an outer periphery of the tube member such that a part of the outer tape member wound later on the outer periphery of the tube member does not overlap a part of the outer tape member wound previously on the outer periphery of the tube member.

10. The wiring harness of claim 1, wherein the exterior member is composed only of the tape member.

11. The wiring harness of claim 1, comprising:
terminals to be fixed to both end parts of each of the plurality of wires;
fixing members to be fixed to both end parts of the tape cutting wire; and
connectors, the terminals and the fixing members being fixed to the connectors.

12. The wiring harness of claim 11, wherein the fixing members are terminals.

13. The wiring harness of claim 11, wherein the fixing members are rubber plugs.
